(19) United States
(12) Patent Application Publication
(10) Pub. No.: US 2021/0120171 A1
(43) Pub. Date: Apr. 22, 2021

(54) DETERMINATION DEVICE, MOVABLE BODY, DETERMINATION METHOD, AND PROGRAM

(71) Applicant: SZ DJI TECHNOLOGY CO., LTD., Shenzhen (CN)

(72) Inventors: Tomonaga YASUDA, Tokyo (JP); Kenichi HONJO, Tokyo (JP)

(21) Appl. No.: 17/115,654

(22) Filed: Dec. 8, 2020

Related U.S. Application Data
(63) Continuation of application No. PCT/CN2019/090725, filed on Jun. 11, 2019.

(30) Foreign Application Priority Data
Jun. 12, 2018 (JP) 2018-112100

(51) Int. Cl. H04N 5/232; H04N 5/225; G02B 7/28; G03B 13/36; G03B 15/00; B64D 47/08; B64C 39/02; G01P 3/38

(52) U.S. Cl. CPC H04N 5/23212; H04N 5/2253; H04N 5/23296; G02B 7/282; G03B 13/36; B64C 2201/127; B64D 47/08; B64C 39/024; G01P 3/38; B64C 2201/027; G03B 15/006

(57) ABSTRACT

A determination device includes a processor and a storage device storing instructions that, when executed by the processor, cause the processor to: determine focus setting values of a photographing device, zoom setting values of the photographing device, and moving speeds of a movable body carrying the photographing device at various time points from a first time point to a second time point according to a time needed to change a zoom ratio of the photographing device from a first zoom ratio to a second zoom ratio, the first zoom ratio, and the second zoom ratio.

### CROSS-REFERENCE TO RELATED APPLICATIONS

This application is a continuation of International Application No. PCT/CN2019/090725, filed Jun. 11, 2019, which claims priority to Japanese Application No. 2018-112100, filed Jun. 12, 2018, the entire contents of both of which are incorporated herein by reference.

### TECHNICAL FIELD

The present disclosure relates to a determination device, a movable body, a determination method and a program.

### BACKGROUND

Patent Document 1 discloses that in order to provide a dolly zoom effect, image analysis is used to automatically adjust a zoom function in accordance with a movement of a camera.

Patent Document 1: Japanese Publication No. 2016-517639.

It is desirable that the camera mounted at a movable body can easily shoot images that provide effects such as a dolly zoom.

### SUMMARY

In accordance with the disclosure, there is provided a determination device including a processor and a storage device storing instructions that, when executed by the processor, cause the processor to determine focus setting values of a photographing device, zoom setting values of the photographing device, and moving speeds of a movable body carrying the photographing device at various time points from a first time point to a second time point according to a time needed to change a zoom ratio of the photographing device from a first zoom ratio to a second zoom ratio, the first zoom ratio, and the second zoom ratio.

Also in accordance with the disclosure, there is provided determination device includes a movable body and a photographing device. The photographing device includes a processor and a storage device storing instructions that, when executed by the processor, cause the processor to determine focus setting values of the photographing device, zoom setting values of the photographing device, and moving speeds of a movable body carrying the photographing device at various time points from a first time point to a second time point according to a time needed to change a zoom ratio of the photographing device from a first zoom ratio to a second zoom ratio, the first zoom ratio, and the second zoom ratio

### BRIEF DESCRIPTION OF THE DRAWINGS

FIG. 1 is a schematic diagram showing an unmanned aerial vehicle (UAV) and a remote operation device according to an embodiment of the disclosure.

FIG. 2 is a diagram showing functional blocks of a UAV according to an embodiment of the disclosure.

FIG. 3 is a diagram showing a positional relationship between a UAV and an object to be shot according to an embodiment of the disclosure.

FIG. 4 is a diagram showing a relationship between a focus lens position and a zoom lens position according to an embodiment of the disclosure.

FIG. 5A is a diagram showing an image shot at a telephoto side by a photographing device according to an embodiment of the disclosure.

FIG. 5B is a diagram showing an image shot at a wide-angle side by a photographing device according to an embodiment of the disclosure.

FIG. 6A is a diagram showing an image shot at a telephoto side by a photographing device according to an embodiment of the disclosure.

FIG. 6B is a diagram showing an image shot at a wide-angle side by a photographing device according to an embodiment of the disclosure.

FIG. 7A is a diagram showing an image shot at a telephoto side by a photographing device according to an embodiment of the disclosure.

FIG. 7B is a diagram showing an image shot at a wide-angle side by a photographing device according to an embodiment of the disclosure.

FIG. 8 is a flowchart of a shooting process of a photographing device according to an embodiment of the disclosure.

FIG. 9 is a diagram of a hardware configuration according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

Various embodiments of the present disclosure are described with reference to flowcharts and block diagrams. A block may represent a stage of a process of performing operations or a “unit” of a device that performs operations. The specific stages and “units” can be implemented by programmable circuits and/or processors. A dedicated circuit may include a digital and/or an analog circuit, or may include an integrated circuit (IC) and/or a discrete circuit. A programmable circuit may include a reconfigurable circuit. The reconfigurable circuit may include a circuit with a logic operation such as logic AND, logic OR, logic XOR, logic NAND, logic NOR, or another logic operation, a flip-flop, a register, a field programmable gate array (FPGA), a programmable logic array (PLA)), or other memory components.

The computer-readable medium may include any tangible device that can store instructions to be executed by a suitable device. As a result, the computer-readable medium with instructions stored is provided with a product including instructions that can be executed to create means for performing operations specified by the flowchart or the block diagram. The computer-readable medium may include electronic storage media, magnetic storage media, optical storage media, electromagnetic storage media, semiconductor storage media, or the like. As a more specific example of the computer-readable medium, it may include a floppy disk (registered trademark), a floppy disk, a hard disk, a random-access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray® disc, a memory stick, or an integrated circuit card, etc.

The computer-readable instructions may include any one of source code or object code described in any combination of one or more programming languages. The source code or object code can include a programming language such as assembly instructions, instruction set architecture (ISA) instructions, machine instructions, machine-related instructions, microcode, firmware instructions, status setting data, or object-oriented programming languages such as Smalltalk, JAVA (registered trademark), C++, etc., or “C” programming language or similar programming languages. The computer-readable instructions may be provided locally or via a wide area network (WAN) such as a local area network (LAN) or an internet to a processor or a programmable circuit of a general-purpose computer, a special-purpose computer, or other programmable data processing device. The processor or programmable circuit can execute computer-readable instructions to create means for performing the operations specified in the flowchart or block diagram. Examples of processors include computer processors, processing units, microprocessors, digital signal processors, controllers, microcontrollers, and so on.

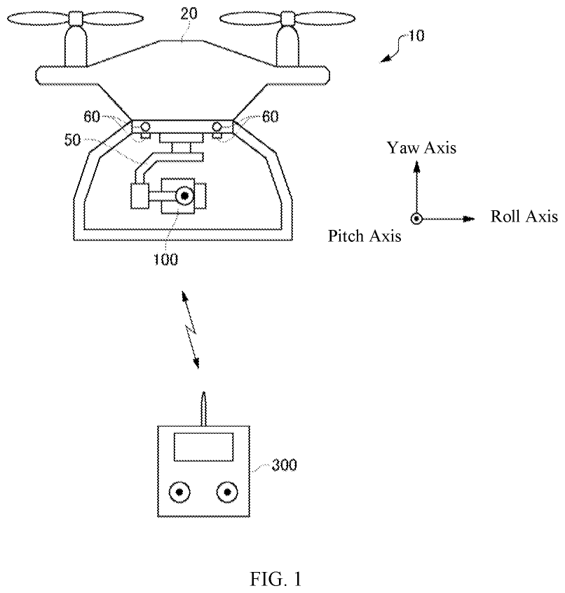

FIG. 1 is a schematic diagram showing an unmanned aerial vehicle (UAV) 10 and a remote operation device 300 according to an embodiment of the disclosure. The UAV 10 includes a UAV body 20, a gimbal 50, a plurality of photographing devices 60, and a photographing device 100. The gimbal 50 and the photographing device 100 are an example of a photographing system. The UAV 10 is an example of a movable body, which can include a flight body movable in the air, a vehicle movable on the ground, or a ship movable on water. The flight bodies movable in the air includes not only UAVs, but also other aircrafts, airships, or helicopters that can move in the air.

The UAV body 20 includes a plurality of rotors. The plurality of rotors are an example of a propulsion unit. The UAV body 20 causes the UAV 10 to fly by controlling the rotation of the plurality of rotors. The UAV body 20 uses, for example, four rotors to fly the UAV 10. The number of rotors is not limited to four. Further, the UAV 10 may also be a fixed-wing aircraft without rotors.

The photographing device 100 may be an imaging camera that shoots an object included in a desired shooting range. The gimbal 50 rotatably supports the photographing device 100. The gimbal 50 is an example of a support mechanism. For example, the gimbal 50 may use an actuator to support the photographing device 100 rotatably around a pitch axis. The gimbal 50 may use actuators to further support the photographing device 100 rotatably around a roll axis and a yaw axis. The gimbal 50 can change an attitude of the photographing device 100 by rotating the photographing device 100 around at least one of the yaw axis, the pitch axis, or the roll axis.

The plurality of photographing devices 60 may be sensing cameras that shoot surroundings of the UAV 10 in order to control the flight of the UAV 10. The two photographing devices 60 may be provided at a nose, that is, the front of the UAV 10. Furthermore, the other two photographing devices 60 may be provided at a bottom surface of the UAV 10. The two photographing devices 60 on the front side may be paired to function as a stereo camera. The two photographing devices 60 on the bottom side may also be paired to function as a stereo camera. Three-dimensional spatial data around the UAV 10 can be generated from images shot by the plurality of photographing devices 60. Further, the number of photographing devices 60 included in the UAV 10 is not limited to four. The UAV 10 may include at least one photographing device 60. The UAV 10 may include at least one photographing device 60 at the nose, a tail, a side surface, a bottom surface, or a top surface of the UAV 10, respectively. An angle of view of the photographing device 60 may be greater than an angle of view of the photographing device 100. The photographing device 60 may have a single focus lens or a fisheye lens.

The remote operation device 300 communicates with the UAV 10 to remotely operate the UAV 10. The remote operation device 300 can wirelessly communicate with the UAV 10. The remote operation device 300 transmits to the UAV 10 instruction information indicating various instructions related to the movement of the UAV 10 such as ascending, descending, accelerating, decelerating, going forward, going backward, or rotating. The instruction information may include instruction information to raise a height of the UAV 10. The instruction information may show the height at which the UAV 10 should be located. The UAV 10 moves to the height indicated by the instruction information received from the remote operation device 300. The instruction information may include an ascending instruction to raise the UAV 10. UAV 10 ascends while receiving the ascending instruction. When the height of the UAV 10 has reached an upper limit of the height, the UAV 10 can restrict the ascending even if the ascending instruction is received.

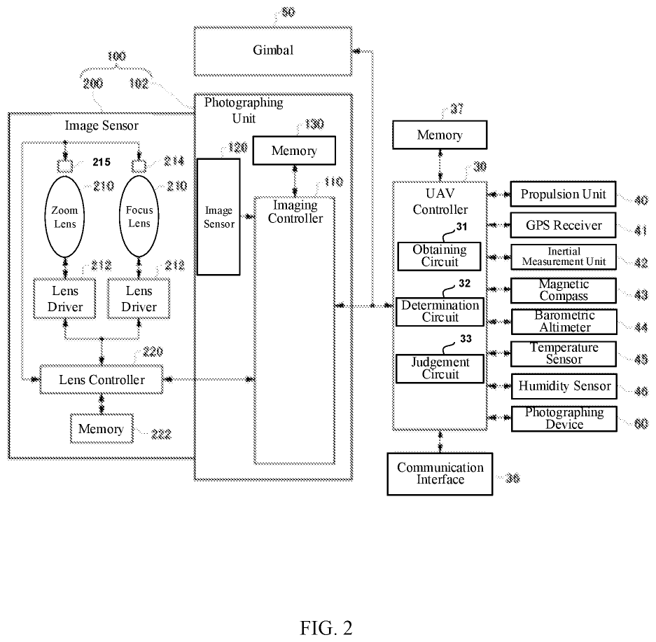

FIG. 2 shows functional blocks of the UAV 10 according to an embodiment of the disclosure. The UAV 10 includes a UAV controller 30, a memory 37, a communication interface 36, a propulsion unit 40, a GPS receiver 41, an inertial measurement unit (IMU) 42, a magnetic compass 43, a barometric altimeter 44, a temperature sensor 45, a humidity sensor 46, a gimbal 50, a photographing device 60 and a photographing device 100.

The communication interface 36 communicates with other devices such as the remote operation device 300. The communication interface 36 may receive instruction information including various instructions to the UAV controller 30 from the remote operation device 300. The memory 37 stores programs that the UAV controller 30 uses to control the propulsion unit 40, the GPS receiver 41, the IMU 42, the magnetic compass 43, the barometric altimeter 44, the temperature sensor 45, the humidity sensor 46, the gimbal 50, the photographing device 60, and the photographing device 100. The memory 37 may be a computer-readable recording medium, and may include at least one of an SRAM, a DRAM, an EPROM, an EEPROM, or a flash memory such as a USB memory or a solid-state drive (SSD). The memory 37 may be provided inside the UAV body 20. The memory may be configured to be detachable from the UAV body 20.

The UAV controller 30 may control a flight and shooting of the UAV 10 in accordance with a program stored in the memory 37. The UAV controller 30 may include a microprocessor such as a CPU or an MPU, a microcontroller such as an MCU, or the like. The UAV controller 30 may control the flight and shooting of the UAV 10 in accordance with instructions received from the remote operation device 300 via the communication interface 36. The propulsion unit 40 propels the UAV 10. The propulsion unit 40 includes a plurality of rotors and a plurality of drive motors that rotate the plurality of rotors. The propulsion unit 40 rotates the plurality of rotors via the plurality of drive motors according an instruction from the UAV controller 30 to cause the UAV 10 to fly.

The GPS receiver 41 receives a plurality of signals indicating the time transmitted from a plurality of GPS satellites. The GPS receiver 41 calculates a position (latitude and longitude) of the GPS receiver 41, that is, a position (latitude and longitude) of the UAV 10, based on the received plurality of signals. The IMU 42 detects an attitude of the UAV 10. The IMU 42 detects accelerations in directions of three axes of front to back, left to right, and up to down, and angular velocities in directions of three axes of a pitch axis, a roll axis, and a yaw axis of the UAV 10 as the attitude of the UAV 10. The magnetic compass 43 detects an orientation of a nose of the UAV 10. The barometric altimeter 44 detects a flying height of the UAV 10. The barometric altimeter 44 detects an air pressure around the UAV 10 and converts the detected air pressure to a height to detect the height. The temperature sensor 45 detects a temperature around the UAV 10. The humidity sensor 46 detects a humidity around the UAV 10.

The photographing device 100 includes a photographing unit 102 and a lens unit 200. In addition to an optical zoom function, the photographing device 100 may also have a digital zoom function. The photographing device 100 may have at least one of the optical zoom function or the digital zoom function. The lens unit 200 is an embodiment of a lens device. The photographing unit 102 includes an image sensor 120, an imaging controller 110, and a memory 130. The image sensor 120 may include CCD or CMOS. The image sensor 120 shoots optical images formed through the lens unit 200 and outputs the shot images to the imaging controller 110. The imaging controller 110 may be constituted by a microprocessor such as a CPU or an MPU, a microcontroller such as an MCU, or the like. The imaging controller 110 may control the photographing device 100 in accordance with an operation instruction of the photographing device 100 from the UAV controller 30. The imaging controller 110 can magnify the image output from the image sensor 120 and cut out a part of the image, thereby implementing the digital zoom.

The memory 130 may be a computer-readable recording medium, and may include at least one of an SRAM, a DRAM, an EPROM, an EEPROM, or a flash memory such as a USB memory or an SSD. The memory 130 stores programs that the imaging controller 110 uses to control the image sensor 120 and the like. The memory 130 may be provided inside a housing of the photographing device 100. The memory 130 may be configured to be detachable from the housing of the photographing device 100.

The lens unit 200 includes a focus lens 210, a zoom lens 211, a lens driver 212, a lens driver 213 and a lens controller 220. The focus lens 210 and the zoom lens 211 may include at least one lens. At least a part of or the entire focus lens 210 and zoom lens 211 are configured to be movable along an optical axis. The lens unit 200 may be an interchangeable lens that is provided to be detachable from the photographing unit 102. The lens driver 212 moves at least a part of or the entire focus lens 210 along the optical axis through a mechanism member such as a cam ring and a guide shaft. The lens driver 213 moves at least a part of or the entire zoom lens 210 along the optical axis through a mechanism member such as a cam ring and a guide shaft. The lens controller 220 drives at least one of the lens driver 212 or the lens driver 213 according to a lens control command from the photographing unit 102, and moves at least one of the focus lens 210 or the zoom lens 211 along the optical axis through a mechanism member to perform at least one of a zoom operation or a focus operation. The lens control command may be a zoom control command or a focus control command.

The lens unit 200 further includes a memory 222, a position sensor 214, and a position sensor 215. The memory 222 stores control values of the focus lens 210 and the zoom lens 211 that are moved via the lens driver 212 and the lens driver 213. The memory 222 may include at least one of an SRAM, a DRAM, an EPROM, an EEPROM, or a flash memory such as a USB memory. The position sensor 214 detects a lens position of the focus lens 210. The position sensor 214 can detect a current focus position. The position sensor 215 detects a lens position of the zoom lens 211. The position sensor 215 can detect a current zoom position of the zoom lens 211.

In the photographing device 100 mounted at the UAV 10 as described above, during the movement of the UAV 10, the zoom function of the photographing device 100 is used to provide moving images a dolly zoom effect such as changing a size of a background on the image plane while maintaining a size of a shooting target of interest on the image plane.

The UAV controller 30 includes an obtaining circuit 31, a determination circuit 32, and a judgement circuit 33. The obtaining circuit 31 obtains a time T needed to change a zoom ratio of the photographing device 100 from a first zoom ratio to a second zoom ratio, the first zoom ratio, and the second zoom ratio. The obtaining circuit 31 may obtain the time, the first zoom ratio, and the second ratio that are pre-stored in the memory 130 or the memory 37. The obtaining circuit 31 may obtain the time T, the first zoom ratio, and the second zoom ratio specified by a user via the remote operation device 300.

The zoom ratio can be an optical zoom ratio, a digital zoom ratio, or a combination of the optical zoom ratio and the digital zoom ratio. The optical zoom ratio refers to a ratio starting from a wide-angle lens. The digital zoom ratio refers to a magnification ratio of an image output from the image sensor 120.

The determination circuit 32 determines focus setting values of the photographing device 100, zoom setting values of the photographing device 100, and moving speeds of the UAV 10 at various time points from a first time point to a second time point based on the time T, the first zoom ratio and the second zoom ratio. The determination circuit 32 may further determine the focus setting values of the photographing device 100, the zoom setting values of the photographing device, and the moving speeds of the UAV 10 at various time points from the first time point to the second time point based on information indicating a first focus distance of the photographing device 100 at the first time point and information indicating a second focus distance of the photographing device 100 at the second time point. The information indicating the first focus distance includes at least one of a distance from the photographing device 100 to a shooting target that enters a focus state at the first time point, or a position of the focus lens 210 that brings the shooting target into the focus state at the first time point. The information indicating the second focus distance includes at least one of a distance from the photographing device 100 to the shooting target that enters the focus state at the second time point, or a position of the focus lens 210 that brings the shooting target into the focus state at the second time point. The focus state includes a state in which an evaluation value of a contrast of the shooting target in an image is equal to or greater than a preset value.

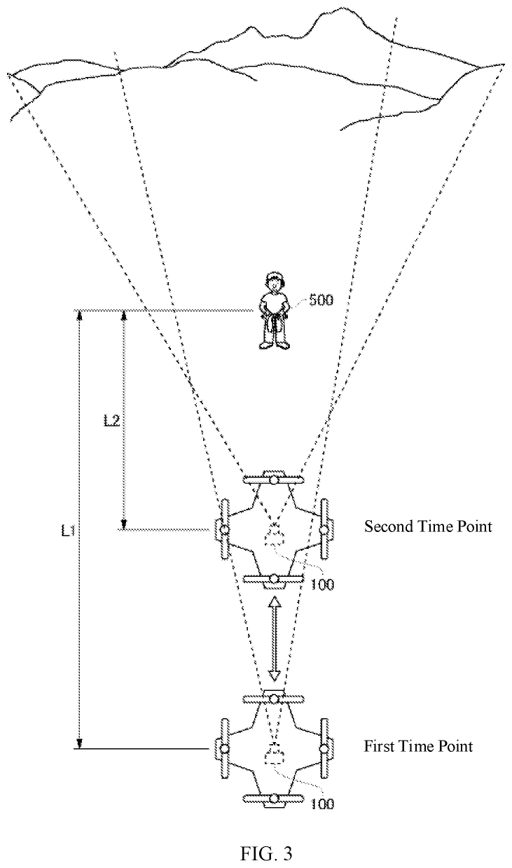

For example, the first zoom ratio is 2, and the second zoom ratio is 1. As shown in FIG. 3, the zoom ratio of the photographing device 100 at the first time point is 2, and a distance from the photographing device 100 to a shooting target 500 (the first focus distance) is L1. Furthermore, the UAV 10 moves in a shooting direction so that a size of the shooting target 500 on an image plane shot with a ratio of 2 is the same as a size of the shooting target 500 on an image plane shot with a ratio of 1. In this scenario, since the zoom ratio of the photographing device 100 at the second time point is 1, a distance from the photographing device 100 to the shooting target 500 at the second time point (the second focus distance) is L2 (=L1/2). That is, the UAV 10 only needs to move a distance of a difference between the first focus distance and the second focus distance (L1−L2=L1/2) along the shooting direction.

The photographing device 100 moves the zoom lens 211 from the first time point to the second time point to change the zoom ratio from 2 to 1. Further, the photographing device 100 changes the focus distance of the focus lens 210 from the first focus distance to the second focus distance from the first time point to the second time point. The first focus distance corresponds to a distance from the photographing device 100 to a first focus position at which focusing is achieved at the first time point. The second focus distance corresponds to a distance from the photographing device 100 to a second focus position at which focusing is achieved at the second time point. Further, the photographing device 100 may also move away from the shooting target 500 from the first time point to the second time point. In this scenario, the first zoom ratio may be 1, and the second zoom ratio may be 2.

The photographing device 100 may perform shooting in a manner of maintaining a focus state for a still single object from the first time point to the second time point. In this scenario, the first focus position is the same as the second focus position. The photographing device 100 may perform shooting in a manner of focusing on a first shooting target at the first time point and focusing on a second shooting target whose distance from the photographing device 100 is different from the first shooting target at a second time point. In this scenario, the first focus position is different from the second focus position.

The determination circuit 32 determines a moving speed of the UAV 10 needed for the UAV 10 to move a distance of the difference between the second focus distance and the first focus distance during the time T.

The determination circuit 32 may determine the focus setting value of the photographing device 100 and the zoom setting value of the photographing device 100 at various time points from the first time point to the second time point based on first information indicating a relationship between a zoom lens position and a focus lens position in the first focus distance and second information indicating a relationship between a zoom lens position and a focus lens position in the second focus distance.

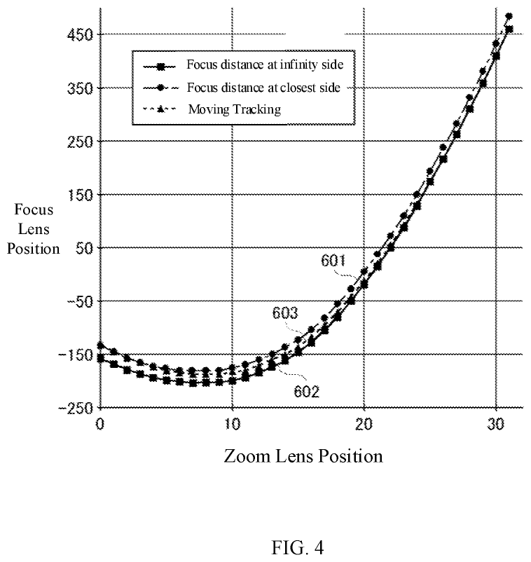

The determination circuit 32 may determine the focus setting values of the photographing device 100 and the zoom setting values of the photographing device 100 at various time points from the first time point to the second time point based on a so-called zoom tracking curve. For example, as shown in FIG. 4, the determination circuit 32 may determine a moving tracking curve 603 based on a zoom tracking curve 602 corresponding to an infinity side focus distance of the first focus distance and a zoom tracking curve 601 corresponding to a closest side focus distance of the second focus distance. The moving tracking curve 603 represents the focus setting values of the photographing device 100 and the zoom setting values of the photographing device 100 at various time points from the first time point to the second time point. The imaging controller 110 outputs a zoom operation instruction and a focus operation instruction to the lens controller 220 to control the zoom lens position and the focus lens position according to the moving tracking curve 603 as shown in FIG. 4 from the first time point to the second time point.

The determination circuit 32 may obtain data of the zoom tracking curve for each focus distance stored in the memory 222 of the lens unit 200, and determine the moving tracking curve based on the obtained data. The moving tracking curve represents the focus setting values of the photographing device 100 and the zoom setting values of the photographing device 100 at various time points from the first time point to the second time point.

The determination circuit 32 may determine the focus setting values of the photographing device 100, the zoom setting values of the photographing device 100, and the moving speeds of the UAV 10 at various time points from the first time point to the second time point, so that a size on the image plane of the shooting target at the first focus position shot at the first time point by the photographing device 100 and a size on the image plane of the shooting target at the second focus position shot at the second time point by the photographing device 100 satisfy a preset condition. The preset condition may be that the size on the image plane of the shooting target at the first focus position shot at the first time point by the photographing device 100 and the size on the image plane of the shooting target at the second focus position shot at the second time point by the photographing device 100 are consistent with each other.

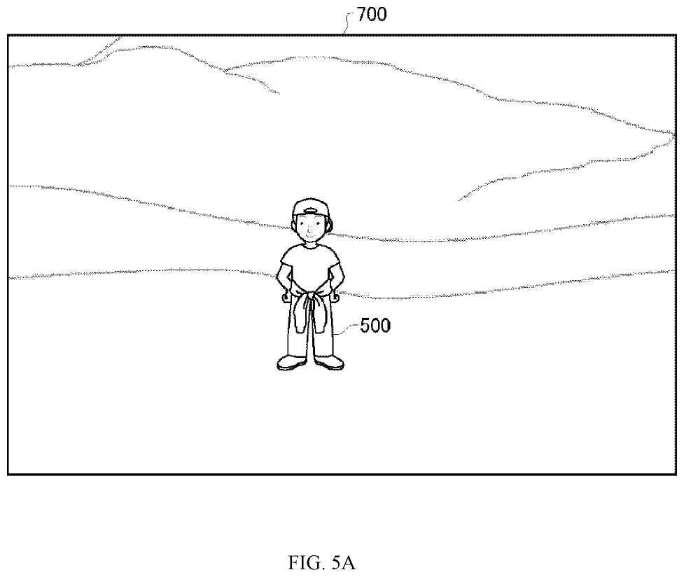

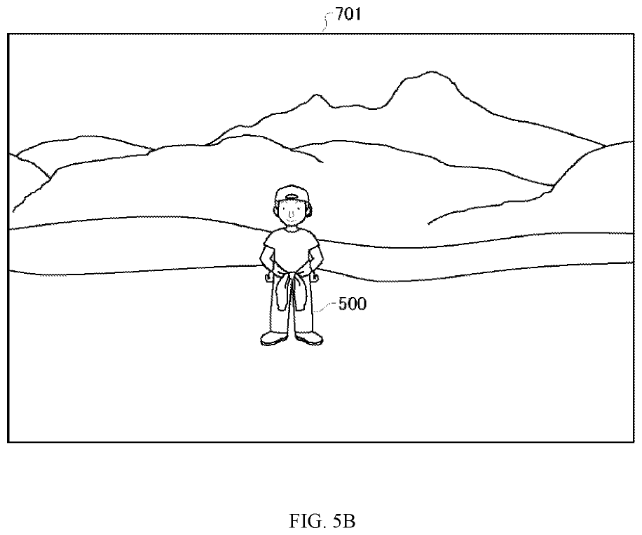

The photographing device 100 may perform shooting in a manner of approaching the shooting target from the first time point to the second time point. When the first focus position and the second focus position are the same, the photographing device 100 may perform shooting while moving relative to the shooting target, so that the first focus distance is longer than the second focus distance. In this scenario, for example, the photographing device 100 shoots an image 700 as shown in FIG. 5A at a first time point with a first focus distance and a first zoom ratio, and shoots an image 701 as shown in FIG. 5B at a second time point with a second focus distance and a second zoom ration less than the first zoom ratio. As a result, the moving images shot from the first time point to the second time point may include an effect that a size of a background on the image plane changes while a size of the shooting target 500 of interest on the image plane maintains.

In some embodiments, when the first focus position is different from the second focus position, the determination circuit 32 may determine the focus setting values of the photographing device 100, the zoom setting values of the photographing device 100, and the moving speeds of the UAV 10 at various time points from the first time point to the second time point, so that the size on the image plane of the shooting target at the first focus position shot at the first time point by the photographing device 100 and the size on the image plane of the shooting target at the second focus position shot at the second time point by the photographing device 100 satisfy a preset condition. In this scenario, the moving images shot from the first time point to the second time point may include an effect that the size of the background on the image plane changes while a state of focusing at a first shooting target of interest existing at the first focus position at the first time point changes to a state of focusing at a second shooting target of interest existing at the second focus position at the second time point.

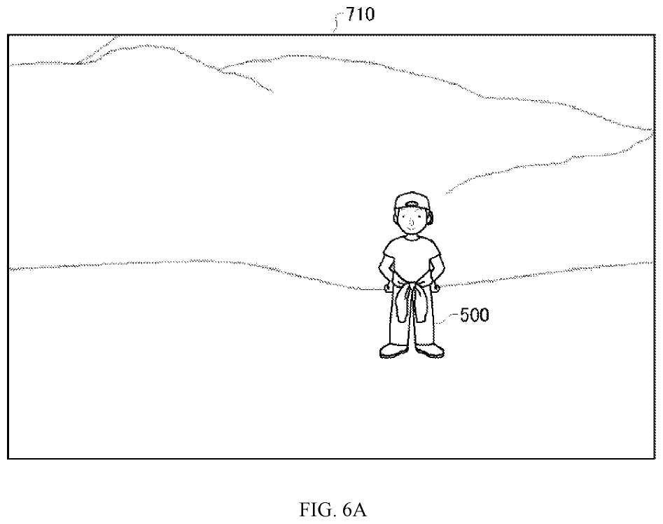

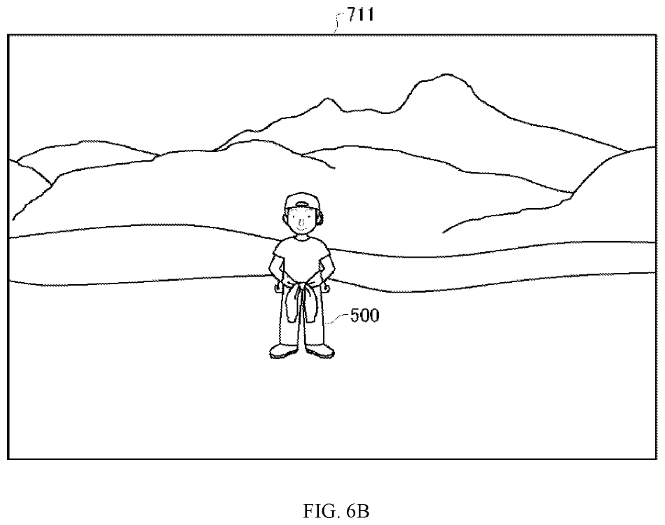

The first shooting target of interest may also be the same as the second shooting target of interest. That is, the shooting target of interest existing at the first focus position at the first time point may also move to the second focus position at the second time point. For example, the photographing device 100 shoots an image 710 including the shooting target 500 in a focus state as shown in FIG. 6A at the first time point with the first focus distance and the first zoom ratio, and shoots an image 711 including the shooting target 500 in a focus state as shown in FIG. 6B at the second time point with the second focus distance and the second zoom ratio less than the first zoom ratio. As a result, the moving images shot from the first time point to the second time point may include an effect that the size of the background on the image plane changes while the size of the shooting target 500 on the image plane maintains during the movement from the first time point to the second time point.

In some embodiments, when the first focus position is different from the second focus position, the determination circuit 32 may determine the focus setting values of the photographing device 100, the zoom setting values of the photographing device 100, and the moving speeds of the UAV 10 at various time points from the first time point to the second time point, so that a size on the image plane of a shooting target at the first focus position shot at the first time point by the photographing device 100 and the size on the image plane of the shooting target at the first focus position shot at the second time point by the photographing device 100 satisfy a preset condition.

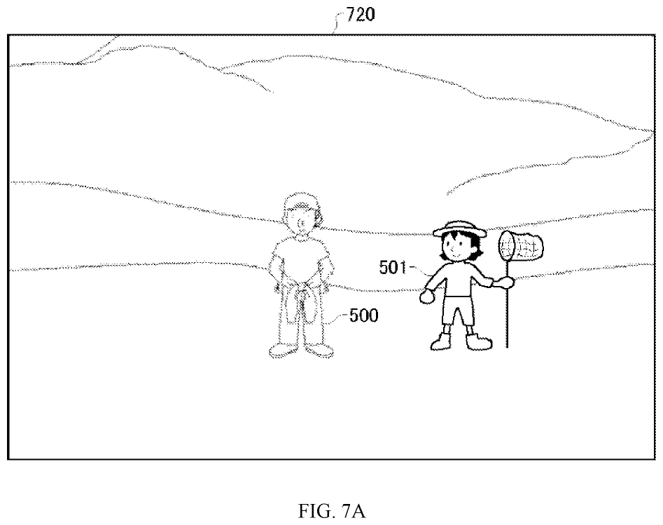

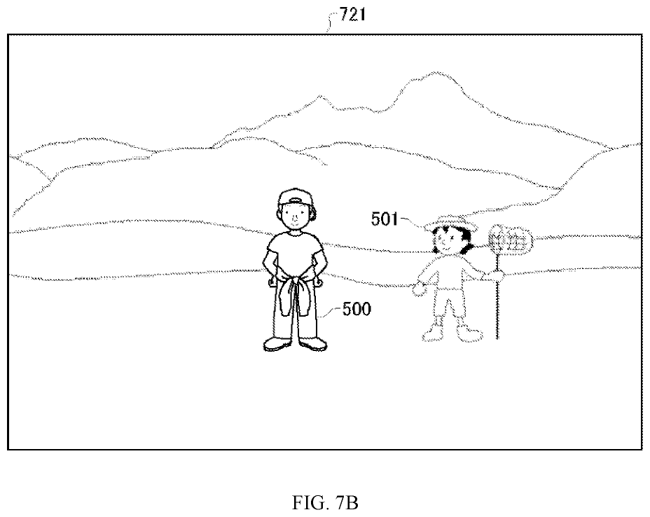

The preset condition may be that the size on the image plane of the shooting target at the first focus position shot at the first time point by the photographing device 100 and the size on the image plane of the shooting target at the first focus position shot at the second time point by the photographing device 100 are consistent with each other. In this scenario, the moving images shot from the first time point to the second time point may include an effect that a size of a background on the image plane changes while a size on the image plane of the shooting target of interest existing at the first focus position maintains. The moving images may include an effect that a shooting target of interest existing at the first focus position enters a focus state at the first time point, and another shooting target of interest existing at the second focus position enters a focus state at the second time point. For example, the photographing device 100 shoots an image 720 including the shooting target 500 entering a focus state and the shooting target 501 in a focus state as shown in FIG. 7A at the first time point with the first focus distance and the first zoom ratio, and shoots an image 721 including the shooting target 500 in a focus state and a shooting target 501 not in a focus state as shown in FIG. 7B at the second time point with the second focus distance and the second zoom ratio less than the first zoom ratio.

In some embodiments, when the first focus position is different from the second focus position, the determination circuit 32 may determine the focus setting values of the photographing device 100, the zoom setting values of the photographing device 100, and the moving speeds of the UAV 10 at various time points from the first time point to the second time point, so that the size on the image plane of the shooting target at the second focus position shot at the first time point by the photographing device 100 and the size on the image plane of the shooting target at the second focus position shot at the second time point by the photographing device 100 satisfy a preset condition.

The preset condition may be that the size on the image plane of the shooting target at the second focus position shot at the first time point by the photographing device 100 and the size on the image plane of the shooting target at the second focus position shot at the second time point by the photographing device 100 are consistent with each other. In this scenario, the moving images shot from the first time point to the second time point may include an effect that a size of a background on the image plane changes while a size on the image plane of the shooting target of interest existing at the second focus position maintains. The moving images may include an effect that a shooting target of interest existing at the second focus position is not in a focus state at the first time point, and the shooting target of interest existing at the second focus position enters a focus state at the second time point.

Compared with a scenario of zooming to a wide-angle side, it is more difficult to obtain a focus state in a scenario of zooming to a telephoto side. One of the reasons is that in the scenario of zooming to the telephoto side, it is difficult to find a shooting target to be focused when a dolly zoom starts. Therefore, in some embodiments, the first focus distance at the first time point is longer than the second focus distance at the second time point. That is, from the first time point to the second time point, the UAV 10 moves in a manner of approaching the shooting target of interest, and the photographing device 100 shoots images. Therefore, it is easy to maintain the focus state of the shooting target of interest from the first time point to the second time point.

For example, the photographing device 100 is actually moved relative to the shooting target, and the obtaining circuit 31 obtains the focus distance from the first time point to the second time point. Further, the photographing device 100 can be moved relative to the shooting target again, and the photographing device 100 can shoot moving images that produce a dolly zoom effect. In this scenario, while the photographing device 100 is moving close to the shooting target, the zoom ratio is changed from the telephoto side to the wide-angle side, and the obtaining circuit 31 can obtain the focus distances. As a result, the photographing device 100 can more easily obtain the focus distances for focusing on the shooting target from the first time point to the second time point. Further, when the photographing device 100 shoots moving images with the dolly zoom effect, and while the photographing device 100 moves away from the shooting target, the focus lens and zoom lens can be controlled according to the previously obtained focus distances and the zoom ratio can be changed from the wide-angle side to the telephoto side for shooting.

The determination circuit 32 may determine the respective control values of the optical zoom and the digital zoom as the zoom setting values of the photographing device 100 at various time points from the first time point to the second time point based on the time T, the first zoom ratio, and the second zoom ratio. The determination circuit 32 may determine the respective control values of the optical zoom and the digital zoom as the zoom setting values of the photographing device 100 to switch from the optical zoom to the digital zoom. The determination circuit 32 may determine the respective control values of the optical zoom and the digital zoom as the zoom setting values of the photographing device 100 to switch from the digital zoom to the optical zoom.

A maximum speed at which the UAV 10 can move is limited. Therefore, according to a length of the time T or a movement distance of the UAV 10 from the first time point to the second time point, the UAV 10 may not be able to move the movement distance during the time T.

A maximum speed at which the zoom lens 211 can move is limited. According to the length of the time T, the zoom lens 211 may not be able to move from a position with the first zoom ratio to a position with the second zoom ratio during the time T.

A minimum speed at which the zoom lens 211 can move is also limited. The zoom lens 211 may not be able to move from the position with the first zoom ratio to the position with the second zoom ratio during the time T. That is, in order to keep moving the zoom lens 211 during the time T, a speed of the zoom lens 211 may be very low.

In some embodiments, when there is an obstacle on a route along which the UAV 10 moves from the first time point to the second time point, the UAV 10 may not be able to move along the route.

In this scenario, the photographing device 100 may not be able to shoot moving images that produce the dolly zoom effect according to the time T, the first zoom ratio, the second zoom ratio, the first focus distance, and the second focus distance.

Therefore, the judgement circuit 33 can judge whether the photographing device 100 can shoot moving images with a dolly zoom effect based on the time T, the first zoom ratio, the second zoom ratio, the first focus distance, and the second focus distance.

The judgement circuit 33 can judge whether the zoom ratio of the photographing device 100 can be changed from the first zoom ratio to the second zoom ratio within the time T according to the time T, the first zoom ratio, the second zoom ratio, at least one of the minimum speed or the maximum speed of the zoom lens 211. When the judgement circuit 33 determines that the zoom ratio of the photographing device 100 can be changed from the first zoom ratio to the second zoom ratio within the time T, the determination circuit 32 may determine the focus setting values of the photographing device 100, the zoom setting values of the photographing device 100, and the moving speeds of the UAV 10 at various time points from the first time point to the second time point.

The judgement circuit 33 can judge whether the UAV 10 can move the distance of the difference between the first focus distance and the second focus distance within the time T according to the time T, the difference between the first focus distance and the second focus distance, and the maximum speed of the UAV 10. When the judgement circuit 33 determines that the UAV 10 can move the distance of the difference between the first focus distance and the second focus distance within the time T, the determination circuit 32 may determine the focus setting values of the photographing device 100, the zoom setting values of the photographing device 100, and the moving speeds of the UAV 10 at various time points from the first time point to the second time point.

The judgement circuit 33 can judge whether there is an obstacle on the route along which the UAV 10 moves the distance of the difference between the first focus distance and the second focus distance. When the judgement circuit 33 determines that there is no obstacle on the route, the focus setting values of the photographing device 100, the zoom setting values of the photographing device, and the moving speeds of the UAV 10 at various time points from the first time point to the second time point can be determined. The judgement circuit 33 can judge whether there is an obstacle on the route along which the UAV 10 moves the distance of the difference between the first focus distance and the second focus distance based on a three-dimensional map stored in the memory 37 and the position information of the UAV 10. The judgement circuit 33 can judge whether there is an obstacle on the route along which the UAV 10 moves the distance of the difference between the first focus distance and the second focus distance based on images shot by the photographing device 100 or the photographing devices 60 that are used as a stereo camera.

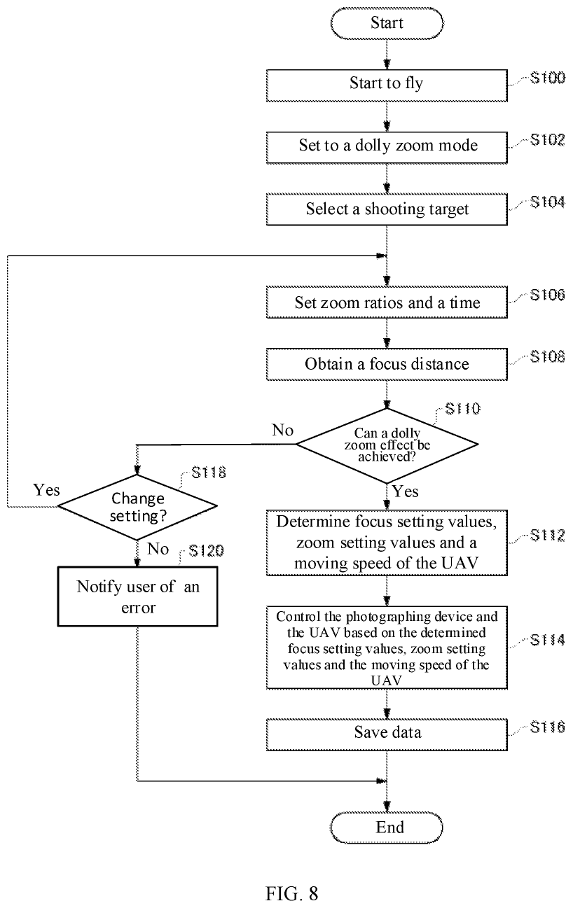

FIG. 8 is a flowchart of a shooting process of the photographing device 100 mounted at the UAV 10 according to an embodiment of the disclosure.

At S100, the UAV 10 starts to fly. At S102, the UAV controller 30 receives a mode setting instruction from the remote operation device 300, and sets a shooting mode of the photographing device 100 to a dolly zoom mode. At S104, the UAV controller 30 receives a selection of a shooting target of interest through a live view of the photographing device 100 displayed on the display of the remote operation device 300. The UAV controller 30 may include a receiving circuit that receives the shooting target of interest from an image shot by the photographing device 100. The receiving circuit may also receive multiple selections of the shooting target of interest from the image. The receiving circuit may receive a selection of the shooting target of interest at a start time of the dolly zoom and a selection of the shooting target of interest at a finish time of the dolly zoom. The receiving circuit may receive selections of the shooting targets of interest at various time points from the start time of the dolly zoom to the finish time of the dolly zoom.

At S106, the UAV controller 30 receives the first zoom ratio at a first time point (the start time of dolly zoom), the second zoom ratio at a second time point (the finish time of dolly zoom), and the time T as a shooting time with the dolly zoom, and sets up via the remote operation device 300. The UAV controller 30 can set the first zoom ratio, the second zoom ratio, and the time T according to the setting information pre-stored in the memory 37 or the like. The UAV controller 30 may only receive whether to change from the telephoto side to the wide-angle side or from the wide-angle side to the telephoto side. The UAV controller 30 may set a preset zoom ratio on the telephoto side and a zoom ratio on the wide-angle side as zoom ratios at the first time point and the second time point based on whether to change from the telephoto side to the wide-angle side or from the wide-angle side to the telephoto side. The UAV controller 30 may receive the time T selected from a plurality of preset candidate times. The UAV controller 30 may set the time T by receiving a desired time mode from a long-time mode, a medium-time mode, or a short-time mode.

At S108, the obtaining circuit 31 obtains information indicating the focus distance, which is a distance from the photographing device 100 to the shooting target of interest. The obtaining circuit 31 may obtain information indicating the first focus distance from the shooting target of interest at the first time point. The obtaining circuit 31 may derive the second focus distance based on the first zoom ratio, the second zoom ratio, and the first focus distance. The obtaining circuit 31 may derive the second focus distance by multiplying the first focus distance by a ratio of the first zoom ratio and the second zoom ratio.

At S110, the judgement circuit 33 judges whether the photographing device 100 can shoot moving images with a dolly zoom effect based on the time T, the first zoom ratio, the second zoom ratio, the first focus distance, and the second focus distance. The judgement circuit 33 can judge whether the photographing device 100 can shoot moving images with the dolly zoom effect based on the time T, the first zoom ratio, the second zoom ratio, the first focus distance, and the second focus distance.

The judgement circuit 33 can judge whether the zoom ratio of the photographing device 100 can be changed from the first zoom ratio to the second zoom ratio within the time T based on the time T, the first zoom ratio, the second zoom ratio, and at least one of the minimum speed or the maximum speed of the zoom lens 211. The judgement circuit 33 can judge whether the UAV 10 can move a distance of the difference between the first focus distance and the second focus distance within the time T based on the time T, the difference between the first focus distance and the second focus distance, and the maximum speed of the UAV 10. The judgement circuit 33 can judge whether there is an obstacle on the route along which the UAV 10 moves the distance of the difference between the first focus distance and the second focus distance.

When the judgement circuit 33 determines that the photographing device 100 cannot shoot moving images with the dolly zoom effect, it notifies the user of a setting change request via the remote operation device 300. The judgement circuit 33 may notify the user of the time T, the first focus distance, or the zoom ratio with which images can be shot with the dolly zoom effect. When the judgement circuit 33 receives the setting change request from the user at process S118, the UAV controller 30 resets the zoom ratio and time in accordance with the setting change request at process S106. When receiving a movement instruction of the UAV 10 from the user, the UAV controller 30 moves the UAV 10 relative to the shooting target to adjust the distance to the shooting target.

At S120, if there is no setting change request, the judgement circuit 33 notifies the user via the remote operation device 300 of an error indicating that images cannot be shot with the dolly zoom effect.

At S112, when images can be shot with the dolly zoom effect, the determination circuit 32 determines the focus setting values of the photographing device 100, the zoom setting values of the photographing device 100, and the moving speeds of the UAV 10 at various time points from the first time point to the second time point. The determination circuit 32 may determine the focus setting values of the photographing device 100, the zoom setting values of the photographing device 100, and the moving speeds of the UAV 10 at various time points from the first time point to the second time point according to the moving tracking curve for the first focus distance at the first time point and the moving tracking curve for the second focus distance at the second time point.

At S114, the UAV controller 30 controls the position of the zoom lens 211, the position of the focus lens 210 and the movement of the UAV 10 according to the focus setting values of the photographing device 100, the zoom setting values of the photographing device 100, and the moving speeds of the UAV 10 at various time points from the first time point to the second time point. Therefore, the photographing device 100 changes the zoom ratio and the focus distance while changing the distance to the shooting target from the first time point to the second time point. For example, the photographing device 100 shoots in a manner of maintaining the size of the shooting target of interest on the image plane while moving from the first time point to the second time point. In this way, the photographing device 100 can shoot a moving image in which the size and focus state of the shooting target of interest on the image plane are maintained while the background size or a blur amount changes.

In the above-described embodiments, an example in which the UAV 10 moves along the shooting direction of the photographing device 100 is described. However, the UAV 10 may move so as to pass by the shooting target, and the gimbal 50 may control an attitude of the photographing device 100 so that the shooting direction of the photographing device 100 faces the shooting target. The UAV 10 may also control the orientation of the UAV 10 to make the shooting direction of the photographing device 100 face the shooting target while moving so as to pass by the shooting target. The UAV 10 may also control the orientation of the UAV 10 and control the attitude of the photographing device 100 via the gimbal 50 to make the shooting direction of the photographing device 100 face the shooting target while moving so as to pass by the shooting target. The UAV 10 can control at least one of the attitude of the photographing device 100 adjusted via the gimbal 50 or the orientation of the UAV 10 to cause the shooting direction of the photographing device 100 to point to the shooting target while ascending or descending. It can be understood from FIG. 4 that the moving tracking range is between the zoom tracking curve 601 and the zoom tracking curve 602. As a result, it can be set that the UAV 10 can move within the moving tracking range. The moving range can be set as a three-dimensional space. That is, by using a moving tracking mode, the moving area of the UAV 10 can be controlled. The moving area of the UAV 10 may be set as a hollow sphere in a three-dimensional space or a hollow hemisphere in a three-dimensional space with the shooting target as a center. The moving area of the UAV 10 may be set based on at least one of the time T, the first zoom ratio, the second zoom ratio, the minimum speed of the zoom lens 211, the maximum speed of the zoom lens 211, or the maximum speed of the UAV 10.

The photographing device 100 may also adjust an aperture from the first time point to the second time point. The determination circuit 32 may determine the aperture values of the photographing device 100 at various time points from the first time point to the second time point based on the time T, the first zoom ratio, the second zoom ratio, the first focus distance, and the second focus distance. The determination circuit 32 may determine the control values of the aperture of the photographing device 100 at various time points from the first time point to the second time point, so that a blur degree of the background from the first time point to the second time point does not change. The determination circuit 32 may determine the aperture with the first zoom ratio (telephoto side) at the first time point as a first control value, and determine the aperture at the second time point with the second ratio (wide-angle side) less than the first zoom ratio as a second control value less than the first control value.

The photographing device 100 may also adjust an F value from the first time point to the second time point. The determination circuit 32 may determine the F values of the photographing device 100 at various time points from the first time point to the second time point based on the time T, the first zoom ratio, the second zoom ratio, the first focus distance, and the second focus distance. The determination circuit 32 may determine the F values of the photographing device 100 at various time points from the first time point to the second time point, so that a brightness value of the shooting target of interest in the images from the first time point to the second time point will not change. The determination circuit 32 may determine the F value with the first zoom ratio (telephoto side) at the first time point as a first control value, and determine the F value at the second time point with the second ratio (wide-angle side) that is less than the first zoom ratio as a second control value that is less than the first control value.

The photographing device 100 can adjust an ISO sensitivity (gain) from the first time point to the second time point. The determination circuit 32 may determine the ISO sensitivity of the photographing device 100 at various time points from the first time point to the second time point based on the time T, the first zoom ratio, the second zoom ratio, the first focus distance, and the second focus distance. The determination circuit 32 may determine the ISO sensitivity and a shutter speed of the photographing device 100 at various time points from the first time point to the second time point based on the time T, the first zoom ratio, the second zoom ratio, the first focus distance, and the second focus distance. The determination circuit 32 may determine the ISO sensitivity and the shutter speed of the photographing device 100 at various time points from the first time point to the second time point based on the time T, the first zoom ratio, the second zoom ratio, the first focus distance, and the second focus distance to keep an exposure constant.

In order to reduce an image flicker, the photographing device 100 may disable an automatic exposure function and an automatic white balance function while operating in the dolly zoom mode.

The UAV 10 can move in such a manner that a selected shooting target of interest is included in a central area of the image shot by the photographing device 100. In some embodiments, the UAV 10 may move in such a manner that any point other than the shooting target of interest in the image shot by the photographing device 100 at the first time point is included in the central area of the image. In the scenario of the dolly zoom, a digital zoom can be performed after an optical zoom. In the scenario of the dolly zoom, an optical zoom can be performed after a digital zoom. In this way, a movement distance of the UAV 10 can be extended. As a result, a dolly zoom effect can be better represented.

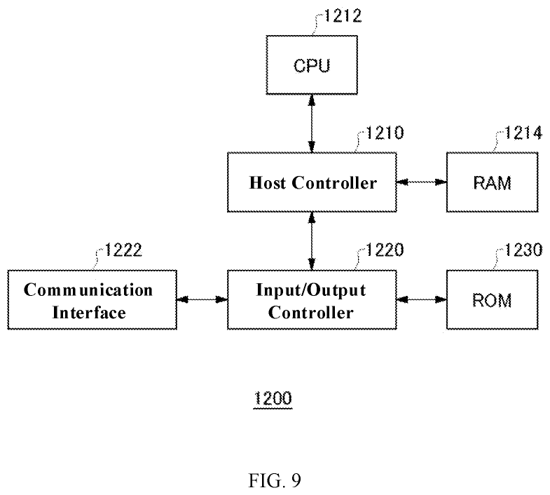

FIG. 9 shows an example of a computer 1200 that may embody one or more aspects of the present disclosure. The program installed on the computer 1200 can make the computer 1200 function as an operation associated with a device according to the embodiments of the present disclosure or one or more “units” of the device. In some embodiments, the program can cause the computer 1200 to perform the operation or the one or more “units.” The program enables the computer 1200 to execute a process or stages of the process consistent with embodiments of the present disclosure. The program can be executed by a CPU 1212 to make the computer 1200 execute specific operations associated with some or all of the blocks in the flowcharts or block diagrams described in this disclosure.

The computer 1200 of this disclosure includes the CPU 1212 and a RAM 1214, which are connected to each other through a host controller 1210. The computer 1200 further includes a communication interface 1222, an input/output unit, which is connected to the host controller 1210 through an input/output controller 1220. The computer 1200 also includes a ROM 1230. The CPU 1212 operates in accordance with programs stored in the ROM 1230 and RAM 1214 to control each unit.

The communication interface 1222 communicates with other electronic devices through a network. A hard disk drive can store programs and data used by the CPU 1212 of the computer 1200. The ROM 1230 stores a bootloader executed by the computer 1200 during operation, and/or a program dependent on the hardware of the computer 1200. The program is provided through a computer-readable medium such as a CR-ROM, a USB memory, or an IC card, or a network. The program is installed in the RAM 1214 or the ROM 1230, which are examples of computer-readable medium, and is executed by the CPU 1212. The information processing described in the programs is read by the computer 1200 and causes cooperation between the program and the various types of hardware resources described above. The device or method may be constituted by realizing the operation or processing of information with the use of the computer 1200.

For example, when a communication is performed between the computer 1200 and an external device, the CPU 1212 can execute a communication program loaded in the RAM 1214, and based on the processing described in the communication program, instruct the communication interface 1222 to perform communication processing. Under the control of the CPU 1212, the communication interface 1222 reads transmission data stored in a transmission buffer provided in a recording medium such as the RAM 1214 or a USB memory, and transmits the read transmission data to a network or writes received data received from the network in a receiving buffer provided in a recording medium.

Further, the CPU 1212 can make the RAM 1214 read all or required parts of files or databases stored in an external recording medium such as a USB memory, and perform various types of processing on the data of the RAM 1214. Then, the CPU 1212 can write the processed data back to the external recording medium.

Various types of information such as various types of programs, data, tables, and databases can be stored in the recording medium, and the information can be processed. For the data read from the RAM 1214, the CPU 1212 can execute various types of operations, information processing, conditional determination, conditional transfer, unconditional transfer, or information retrieval/replacement specified by the instruction sequence of the program described in the disclosure, and write the result back to the RAM 1214. In addition, the CPU 1212 can retrieve information in files, databases, or the like in the recording medium. For example, when a plurality of entries having attribute values of first attributes respectively associated with attribute values of second attributes are stored in the recording medium, the CPU 1212 may retrieve an entry that matches the condition that specifies the attribute value of the first attribute from the plurality of entries and read the attribute value of the second attribute stored in the entry to obtain the attribute value of the second attribute associated with the first attribute meeting a preset condition.

The programs or software modules described above may be stored at the computer 1200 or at a computer-readable storage medium near the computer 1200. In addition, a recording medium such as a hard disk or a RAM provided in a server system connected to a dedicated communication network or the internet can be used as a computer-readable storage medium to provide the program to the computer 1200 through the network.

The execution order of the actions, sequences, steps, and stages of the devices, systems, programs, and methods shown in the claims, specification, and drawings of the disclosure, can be implemented in any order as long as there is no special indication such as “before,” “in advance,” etc., and the output of the previous processing is not used in the subsequent processing. Regarding the operation procedures in the claims, the specification, and the drawings of the disclosure, the description is made using “first,” “next,” etc. for convenience, but it does not mean that the operations must be implemented in this order.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

### REFERENCE NUMERALS

10—UAV 20—UAV Body 30—UAV Controller 31—Obtaining Circuit 32—Determination Circuit 33—Judgement Circuit 36—Communication Interface 37—Memory 40—Propulsion Unit 41—GPS Receiver 42—Inertial Measurement Unit 43—Magnetic Compass 44—Barometric Altimeter 45—Temperature Sensor 46—Humidity Sensor 50—Gimbal 60—Photographing Device 100—Photographing Device 102—Photographing Unit 110—Imaging Controller 120—Image Sensor 130—Memory 200—Lens Unit 210—Focus Lens 211—Zoom Lens 212, 213—Lens Driver 214, 215—Position Sensor 220—Lens Controller 222—Memory 300—Remote Operation Device 1200—Computer 1210—Host Controller 1212—CPU 1214—RAM 1220—Input/Output Controller 1222—Communication Interface 1230—ROM

What is claimed is:

1. A determination device comprising:
a processor; and
a storage device storing instructions that, when executed by the processor, cause the processor to:
determine focus setting values of a photographing device, zoom setting values of the photographing device, and moving speeds of a movable body carrying the photographing device at various time points from a first time point to a second time point according to a time needed to change a zoom ratio of the photographing device from a first zoom ratio to a second zoom ratio, the first zoom ratio, and the second zoom ratio.

2. The determination device of claim 1, wherein the instructions further cause the processor to determine the focus setting values of the photographing device, the zoom setting values of the photographing device, and the moving speeds of the movable body at the various time points from the first time point to the second time point based on information indicating a first focus distance of the photographing device at the first time point and information indicating a second focus distance of the photographing device at the second time point.

3. The determination device of claim 2, wherein:
the photographing device includes a zoom lens and a focus lens; and
the instructions further cause the processor to determine the focus setting values and the zoom setting values of the photographing device based on first information indicating a relationship between a zoom lens position and a focus lens position at the first focus distance and second information indicating a relationship between a zoom lens position and a focus lens position at the second focus distance.

4. The determination device of claim 2, wherein:
the first focus distance corresponds to a distance from the photographing device to a first focus position at which focusing is achieved at the first time point; and
the second focus distance corresponds to a distance from the photographing device to a second focus position at which focusing is achieved at the second time point.

5. The determination device of claim 4, wherein the first focus position is same as the second focus position

6. The determination device of claim 4, wherein the first focus position is different from the second focus position.

7. The determination device of claim 4, wherein the first focus distance is longer than the second focus distance.

8. The determination device of claim 4, wherein the instructions further cause the processor to determine the focus setting values of the photographing device, the zoom setting values of the photographing device, and the moving speeds of the movable body at the various time points from the first time point to the second time point, so that a first size on an image plane of a shooting target at the first focus position shot at the first time point by the photographing device and a second size on an image plane of the shooting target at the second focus position shot at the second time point by the photographing device satisfy a preset condition.

9. The determination device of claim 8, wherein the preset condition includes that the first size and the second size are consistent with each other.

10. The determination device of claim 8, wherein the first focus position is same as the second focus position.

11. The determination device of claim 8, wherein the first focus position is different from the second focus position.

12. The determination device of claim 4, wherein:
the first focus position is different from the second focus position; and
the instructions further cause the processor to determine the focus setting values of the photographing device, the zoom setting values of the photographing device, and the moving speeds of the movable body at the various time points from the first time point to the second time point, so that a size on an image plane of a shooting target at the first focus position shot at the first time point by the photographing device and a size on the image plane of the shooting target at the first focus position shot at the second time point by the photographing device satisfy a preset condition.

13. The determination device of claim 4, wherein:
the first focus position is different from the second focus position; and
the instructions further cause the processor to determine the focus setting values of the photographing device, the zoom setting values of the photographing device, and the moving speeds of the movable body at the various time points from the first time point to the second time point, so that a size on an image plane of a shooting target at the second focus position shot at the first time point by the photographing device and a size on the image plane of the shooting target at the second focus position shot at the second time point by the photographing device satisfy a preset condition.

14. The determination device of claim 2, wherein the instructions further cause the processor to:
judge whether the movable body is able to move a distance equaling a difference between the first focus distance and the second focus distance within the time according to the time, the difference between the first focus distance and the second focus distance, and a maximum speed of the movable body; and
in response to judging that the movable body is able to move the distance equaling the difference between the first focus distance and the second focus distance within the time, determine the focus setting values of the photographing device, the zoom setting values of the photographing device, and the moving speeds of the movable body at various time points from the first time point to the second time point.

15. The determination device of claim 2, wherein the instructions further cause the processor to:
judge whether there is an obstacle on a route along which the movable body moves a distance equaling a difference between the first focus distance and the second focus distance; and
in response to judging there is no obstacle on the route, determine the focus setting values of the photographing device, the zoom setting values of the photographing device, and the moving speeds of the movable body at the various time points from the first time point to the second time point.

16. The determination device of claim 1, wherein:
the photographing device includes a zoom lens; and
the instructions further cause the processor to:
judge whether the zoom ratio of the photographing device is able to be changed from the first zoom ratio to the second zoom ratio within the time according to the time, the first zoom ratio, the second zoom ratio, and at least one of a minimum speed or a maximum speed of the zoom lens; and
in response to judging that the zoom ratio of the photographing device is able to be changed from the first zoom ratio to the second zoom ratio within the time, determine the focus setting values of the photographing device, the zoom setting values of the photographing device, and the moving speeds of the movable body at the various time points from the first time point to the second time point.

17. The determination device of claim 1, wherein:
the photographing device includes an optical zoom and a digital zoom; and
the instructions further cause the processor to determine respective control values of the optical zoom and the digital zoom as the zoom setting values of the photographing device at the various time points from the first time point to the second time point based on the time, the first zoom ratio, and the second zoom ratio.

18. A movable body comprising:
a photographing device; and
a determination device including:
a processor; and
a storage device storing instructions that, when executed by the processor, cause the processor to determine focus setting values of the photographing device, zoom setting values of the photographing device, and moving speeds of a movable body carrying the photographing device at various time points from a first time point to a second time point according to a time needed to change a zoom ratio of the photographing device from a first zoom ratio to a second zoom ratio, the first zoom ratio, and the second zoom ratio.

19. The movable body of claim 18, wherein the instructions further cause the processor to determine the focus setting values of the photographing device, the zoom setting values of the photographing device, and the moving speeds of the movable body at the various time points from the first time point to the second time point based on information indicating a first focus distance of the photographing device at the first time point and information indicating a second focus distance of the photographing device at the second time point.

20. The movable body of claim 19, wherein:
the photographing device includes a zoom lens and a focus lens; and
the instructions further cause the processor to determine the focus setting values and the zoom setting values of the photographing device based on first information indicating a relationship between a zoom lens position and a focus lens position at the first focus distance and second information indicating a relationship between a zoom lens position and a focus lens position at the second focus distance.
